(19) United States
(12) Patent Application Publication
(10) Pub. No.: US 2025/0234063 A1
(43) Pub. Date: Jul. 17, 2025

(54) SECURE VIDEO DISSEMINATION SYSTEM AND VIDEO PLAYBACK CLIENT DEVICE APPLIED THERETO

(71) Applicant: LEXO MEDIA GROUP, INC., HOUSTON, TX (US)

(72) Inventor: ZHENZHOU GU, HOUSTON, TX (US)

(21) Appl. No.: 19/098,776

(22) Filed: Apr. 2, 2025

(51) Int. Cl. H04N 21/44; H04N 21/2347; H04N 21/266; H04N 21/433

(52) U.S. Cl. CPC H04N 21/44016; H04N 21/2347; H04N 21/26613; H04N 21/433

(57) ABSTRACT

The present invention provides a secure video dissemination system and a video playback client device applied thereto. The secure video dissemination system includes first means for encrypting video data according to a preset encryption method and second means for disseminating video data according to a preset dissemination method. In the secure video dissemination system, the first means for encrypting the video data generates encrypted video data and an encrypted video access symbol according to received raw video data and raw video access symbol; the second means for disseminating the video data, after receiving a video playback request, responds the corresponding encrypted video data to the video playback client device; if there is no decryption means for decrypting the encrypted video data to obtain the raw video data in the video playback client device, the video cannot be played, which secures video digital.

### TECHNICAL FIELD

The present invention relates to the field of digital content protection, and in particular to a secure video dissemination system and a video playback client device applied thereto.

### BACKGROUND

With the popularization of the Internet and the explosive growth of digital content, the protection of digital content is becoming increasingly serious. DRM technology emerged in the 1990s, aiming at preventing unauthorized copying, dissemination and distribution of digital content through technical means. Early DRM mainly relied on encryption technology to encrypt digital content, so that unauthorized users could not access or use it.

With the development of technology, the DRM technology has formed a variety of solutions. Hardware encryption is implemented through dedicated chips and has relatively high security; software encryption relies on operating systems and software applications and has relatively low security; and digital watermarking technology embeds information into digital content to track infringement.

However, in recent years, with the rise of mobile Internet, the previous DRM technology can no longer meet the video protection needs, and video protection is facing new challenges. It is necessary to ensure that videos are difficult to be cracked within a certain period of time to achieve secure dissemination of videos.

### SUMMARY

The present invention aims to solve at least one of the technical problems existing in the prior art or related art.

In view of this, one or more embodiments of this specification provide a secure video dissemination system and a video playback client device applied thereto, which can ensure that unauthorized users cannot play videos and guarantee the security of video dissemination.

According to a first aspect of one or more embodiments of this specification, there is proposed a secure video dissemination system, including:
first means for encrypting video data according to a preset encryption method, where the preset encryption method includes:
receiving raw video data and a raw video access symbol transmitted by a video publisher and generating encrypted video data and an encrypted video access symbol; and
storing the encrypted video data to an object storage, and returning the encrypted video access symbol to the video publisher; and
second means for disseminating video data according to a preset dissemination method, where the preset dissemination method includes:
receiving a video playback request sent by a video playback client device and acquiring an encrypted video access symbol corresponding to the video playback request; and
responding the encrypted video data corresponding to the encrypted video access symbol to the video playback client device, so that the video playback client device can call decryption means with a preset decryption method to decrypt the encrypted video data to obtain the raw video data, where the decryption means is preinstalled in the video playback client.

In some alternative embodiments, the receiving raw video data and the raw video access symbol transmitted by the video publisher and generating the encrypted video data and the encrypted video access symbol includes:
sharding the raw video data into first raw video data and second raw video data;
randomly extracting third raw video data having a preset length from the second raw video data and recording first position information of the third raw video data, the first position information referring to position information of the third raw video data in the second raw video data;
acquiring a first key based on the third raw video data and a current timestamp;
encrypting the first raw video data according to the first key and a preset encryption algorithm to acquire first encrypted video data, where the preset encryption algorithm for encrypting the video data is prestored in the first means;
generating first decrypted data and second decrypted data based on the current timestamp and the third raw video data, the first decrypted data comprising the current timestamp and first position information, where the second decrypted data include second position information of the current timestamp and the third raw video data in the first decrypted data; and
splicing the second decrypted data, the first decrypted data, the first encrypted video data and the second raw video data to generate the encrypted video data.

In some alternative embodiments, the receiving raw video data and the raw video access symbol transmitted by the video publisher and generating the encrypted video data and the encrypted video access symbol includes:
extracting first 1024 bytes of data from the raw video data as the first raw video data, and using the remaining data that is not extracted as the second raw video data;
randomly extracting the third raw video data having a length of 8 bytes from first 1024 bytes of the second raw video data, and acquiring the first position information of the third raw video data, the first position information referring to the position information of the third raw video data in the second raw video data;
performing MD5_hash calculation on the third raw video data and the current timestamp to obtain the first key;
randomly extracting a symmetric encryption method from a preset symmetric encryption algorithm set as the preset encryption algorithm, and encrypting the first raw video data using the first key and the preset encryption algorithm to acquire the first encrypted video data, the preset symmetric encryption algorithm set is prestored in the first means;
randomly generating the first decrypted data having a length of 1000 bytes based on the current timestamp and the first position information, recording second position information of the current timestamp and the first position information in the first decrypted data, and generating the second decrypted data having a length of 24 bytes according to the second position information; and
splicing the second decrypted data, the first decrypted data, the first encrypted video data and the second raw video data to generate the encrypted video data.

In some alternative embodiments, the preset symmetric encryption algorithm set comprises AES, DES and 3DES.

In some alternative embodiments, the receiving raw video data and the raw video access symbol transmitted by the video publisher and generating the encrypted video data and the encrypted video access symbol includes:
determining a preset second key according to the raw video access symbol; and
encrypting the raw video access symbol according to the second key and a default encryption algorithm to generate the encrypted video access symbol, where the default encryption algorithm for encrypting the video access symbol is prestored in the first means.

In some alternative embodiments, the default encryption algorithm is AES.

In some alternative embodiments, the returning the encrypted video data corresponding to the encrypted video access symbol to the video playback client device includes:
confirming whether the encrypted video data corresponding to the encrypted video access symbol is stored in the object storage according to the encrypted video access symbol;
if so, responding the encrypted video data stored in the object storage to the video playback client device; and
if not, confirming the raw video access symbol corresponding to the encrypted video access symbol based on the encrypted video access symbol, acquiring the encrypted video data based on the raw video access symbol, and responding to the video playback client device.

According to a second aspect of one or more embodiments of this specification, there is proposed a video playback client device applied to a secure video dissemination system, and the video playback client device includes:
third means for initiating a video playback request to second means according to a preset requesting video method, where the preset requesting video method includes:
in response to a video playback instruction initiated by a user, transmitting a video playback request corresponding to the video playback instruction to the second means in the secure video dissemination system, where the video playback request is used for the video playback client device to pull encrypted video data corresponding to the video playback instruction from the second means in the secure video dissemination system;
fourth means for receiving a response from the second means of the secure video dissemination system;
decryption means for decrypting the encrypted video data according to a preset decryption method to obtain raw video data; and
playback means for playing the raw video data.

In some alternative embodiments, the preset decryption method includes:
splitting the encrypted video data into second decrypted data, first decrypted data, first encrypted video data and second raw video data;
acquiring a current timestamp and first position information from the first decrypted data according to the second decrypted data, and acquiring third raw video data from the second raw video data according to the first position information;
acquiring a decryption key based on the current timestamp and the third raw video data; decrypting the first encrypted video data based on the decryption key to acquire first raw video data; and
splicing the first raw video data and the second raw video data to acquire the raw video data.

In some alternative embodiments, the preset decryption method includes:
extracting first 24 bytes of data from the encrypted video data as the second decrypted data, extracting 25th to 1024th bytes of data from the encrypted video data as the first decrypted data, and extracting 1025th to 2048th bytes of data from the encrypted video data as the first encrypted video data;
determining second position information of the current timestamp and the first position information in the first decrypted data according to the extracted second decrypted data, acquiring the current timestamp and the first position information from the first decrypted data, and acquiring the third raw video data from the second raw video data according to the first position information;
performing MD5 calculation on the current timestamp and the third raw video data to obtain a decryption key;
decrypting the first encrypted video data based on the decryption key to acquire first raw video data; and
splicing the first raw video data and the second raw video data to acquire the raw video data.

As can be seen from the above technical solution, in one or more embodiments of this specification, in the video dissemination system, the first means for encrypting the video data according to the preset encryption method generates the encrypted video data and the encrypted video access symbol after receiving the raw video data and the raw video access symbol transmitted by the video publisher; and stores the encrypted video data to the object storage, and returns the encrypted video access symbol to the video publisher; and the second means for disseminating the video data according to the preset dissemination method acquires the encrypted video access symbol corresponding to the video playback request after receiving the video playback request transmitted by the video playback client; and responds the encrypted video data corresponding to the encrypted video access symbol to the video playback client device based on the encrypted video access symbol, so that the video playback client device calls the decryption means to decrypt the encrypted video data to obtain the raw video data. In the technical solution provided by the present application, after receiving the raw video data and the raw video access symbol, the first means encrypts the raw video data and the raw video access symbol respectively to generate the encrypted video data and the encrypted video access symbol; and after receiving the video playback request initiated by the video playback client device, the second means responds the corresponding encrypted video data to the video playback client device, if the video playback client device is installed with decryption means, the decryption means decrypts the encrypted video data to acquire the raw video data and normally plays the raw video data by the playback means, and if there is no decryption means in the video playback client device, the encrypted video data cannot be played. Through the double encryption of the video access symbol and video content, and the decryption verification mechanism of the video playback client device, unauthorized users cannot play video, ensuring the security of video dissemination.

It is to be understood that both the foregoing general description and the following detailed description are exemplary and explanatory only and are not restrictive of the present application.

### BRIEF DESCRIPTION OF THE DRAWINGS

Various other advantages and benefits will become apparent to those of ordinary skill in the art upon reading the following detailed description of preferred embodiments. The drawings are only for purposes of illustrating the preferred embodiments and are not to be construed as limiting the application. Moreover, like components are denoted by like reference numerals throughout the drawings. In the drawings:

FIG. 1 is a system architecture diagram of a secure video dissemination system according to Embodiment 1;

FIG. 2 is a flowchart of a preset encryption method executed by first means for encrypting video data according to the preset encryption method according to Embodiment 1;

FIG. 3 is a flowchart of a preset dissemination method executed by second means for disseminating video data according to the preset dissemination method according to Embodiment 1;

FIG. 4 is a schematic structural diagram of raw video data and encrypted video data according to Embodiment 1;

FIG. 5 is a structural block diagram of a video playback client device applied to a secure video dissemination system according to Embodiment 2; and

FIG. 6 is a flowchart of a preset decryption method executed by decryption means for decrypting the encrypted video data according to the preset decryption method to obtain raw video data according to Embodiment 2.

### DESCRIPTION OF THE EMBODIMENTS

Embodiment 1 and Embodiment 2, examples of which are shown in the drawings, will be described in detail herein. When the following description refers to the drawings, unless otherwise indicated, the same numbers in different drawings represent the same or similar elements. The implementations set forth in the following description of exemplary embodiments do not represent all implementations consistent with one or more embodiments of this specification. Rather, they are merely examples of apparatuses and methods consistent with some aspects of one or more embodiments of this specification as detailed in the appended claims.

It should be noted that in other embodiments, the steps of the corresponding method are not necessarily performed in the order shown and described in this specification. In some other embodiments, the method may include more or fewer steps than described in this specification. In addition, a single step described in this specification may be decomposed into multiple steps for description in other embodiments; and multiple steps described in this specification may also be combined into a single step for description in other embodiments.

In view of the new challenges faced by the security protection of video content, one or more embodiments of this specification provide a secure video dissemination system and a video playback client, which double encrypt the video content and the video access symbol, and then combine the decryption verification of the video playback client to ensure that videos are difficult to be cracked within a certain period of time, thus ensuring the security of video dissemination.

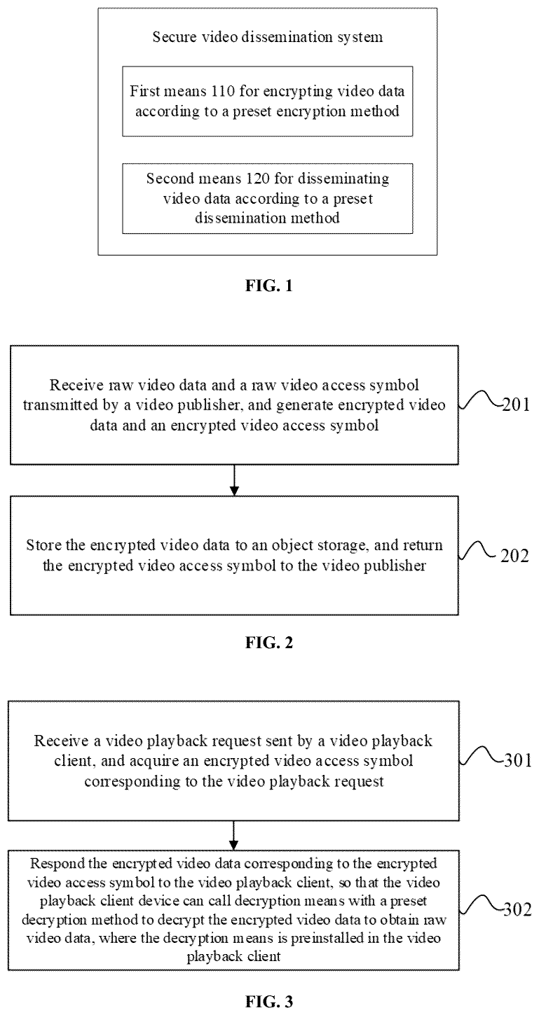

Referring to FIG. 1, FIG. 1 is a system architecture diagram of a secure video dissemination system according to Embodiment 1, and as shown in FIG. 1, the system includes first means 110 for encrypting video data according to a preset encryption method, and second means 120 for disseminating video data according to a preset dissemination method. Referring to FIG. 2, FIG. 2 is a flowchart of a preset encryption method executed by the first means 110 for encrypting video data according to the preset encryption method according to Embodiment 1, and as shown in FIG. 2, the preset encryption method includes:
Step 201, receiving raw video data and a raw video access symbol transmitted by a video publisher and generating encrypted video data and an encrypted video access symbol; and
Step 202, storing the encrypted video data to an object storage, and returning the encrypted video access symbol to the video publisher.

Referring to FIG. 3, FIG. 3 is a flowchart of a preset dissemination method executed by the second means 120 for disseminating video data according to the preset dissemination method according to Embodiment 1, and as shown in FIG. 3, the preset dissemination method includes:
Step 301, receiving a video playback request sent by a video playback client device and acquiring an encrypted video access symbol corresponding to the video playback request; and
Step 302, responding the encrypted video data corresponding to the encrypted video access symbol to the video playback client device, so that the video playback client device can call decryption means to decrypt the encrypted video data to obtain the raw video data, where the decryption means is preinstalled in the video playback client, and is configured to decrypt the encrypted video data according to a preset decryption method to obtain raw video data.

In the present embodiment, the first means 110 for encrypting the video data according to the preset encryption method receives the raw video data and the raw video access symbol transmitted by the video publisher, generates the encrypted video data and the encrypted video access symbol; and stores the encrypted video data to the object storage, and returns the encrypted video access symbol to the video publisher; and the second means 120 for disseminating the video data according to the preset dissemination method receives the video playback request transmitted by the video playback client device, acquires the encrypted video access symbol corresponding to the video playback request; and responds the encrypted video data corresponding to the encrypted video access symbol to the video playback client device based on the encrypted video access symbol, so that the video playback client device calls the decryption means to decrypt the encrypted video data to obtain the raw video data. In the technical solution provided by the present application, after receiving the raw video data and the raw video access symbol, the first means 110 for encrypting the video data according to the preset encryption method performs encryption processing on the raw video data and the raw video access symbol respectively to generate the encrypted video data and the encrypted video access symbol; and after receiving the video playback request initiated by the video playback client device, the second device 120 for disseminating the video data according to the preset dissemination method responds the corresponding encrypted video data to the video playback client device, if the video playback client device is installed with decryption means, the decryption means can be called to decrypt the encrypted video data to acquire the raw video data, and the raw video data is normally played by the playback means, and if there is no decryption means in the video playback client device, the encrypted video data cannot be played. Through the double encryption of the video access symbol and video content, and the decryption verification mechanism of the video playback client device, unauthorized users cannot play video, ensuring the security of video dissemination.

Specifically, in the present embodiment, the raw video data is shown in FIG. 4(a), the encrypted video data is shown in FIG. 4(b), and step 201 may include the following substeps.

Step 2011, sharding the raw video data into first raw video data and second raw video data.

In the present embodiment, first 1024 bytes of data are extracted from the raw video data as the first raw video data D1, and the remaining data that is not extracted is used as the second raw video data D2.

Step 2012, randomly extracting third raw video data having a preset length from the second raw video data and recording first position information of the third raw video data, where the first position information refers to position information of the third raw video data in the second raw video data.

In the present embodiment, a third raw video data D3 having a length of 8 bytes is randomly extracted from first 1024 bytes of the second raw video data D2, and the first position information of the third raw video data is recorded, where the first position information refers to the position information of the third raw video data D3 in the second raw video data D2.

Step 2013, acquiring a first key based on the third raw video data and a current timestamp.

In the present embodiment, MD5_hash calculation is performed on the third raw video data D3 and the current timestamp TS to obtain the first key K1.

Step 2014, encrypting the first raw video data according to the first key and a preset encryption algorithm to acquire first encrypted video data, where the first means 110 for encrypting the video data according to the preset encryption method prestores the preset encryption algorithm for encrypting the video data.

In the present embodiment, when the first means 110 for encrypting the video data according to the preset encryption method prestores a preset symmetric encryption method set, a plurality of symmetric encryption methods are prestored in the preset symmetric encryption method set, and the symmetric encryption methods may include Advanced Encryption Standard (AES), Data Encryption Standard (DES), Triple DES (3DES) and the like. In order to further improve the security of video dissemination, in the present embodiment, a symmetric encryption method is randomly extracted from the preset symmetric encryption method set as the preset encryption algorithm, and then the first raw video data D1 is encrypted using the first key K1 and the preset encryption algorithm to acquire the first encrypted video data D4.

In the present embodiment, only the first raw video data D1 having a length of 1024 bytes is encrypted, which belongs to lightweight encryption of video data, and can realize fast encryption.

Step 2015, generating first decrypted data and second decrypted data based on the current timestamp and the first position information, so that the first decrypted data include the current timestamp and the first position information, the second decrypted data include second position information, and the second position information refers to position information of the current timestamp and the first position information in the first decrypted data.

In the present embodiment, the first decrypted data H1 having a length of 1000 bytes is randomly generated based on the current timestamp TS and the first position information, second position information of the current timestamp TS and the first position information in the first decrypted data H1 is recorded, and the second decrypted data H2 having a length of 24 bytes is generated according to the second position information.

Step 2016, splicing the second decrypted data, the first decrypted data, the first encrypted video data and the second raw video data to generate the encrypted video data.

In the present embodiment, the second decrypted data H2, the first decrypted data H1, the first encrypted video data D4 and the second raw video data D2 are spliced to generate the encrypted video data H2+H1+D4+D2.

In another feasible embodiment, step 201 may further include the following substeps.

Step 2017, determining a preset second key according to the raw video access symbol.

In the present embodiment, a key for encrypting the raw video access symbol is pre-agreed between the video publisher and the first means 110; and after receiving the raw video access symbol, the first means 110 may determine a key preassigned by the video publisher as a preset second key according to the raw video access symbol.

In the present embodiment, the raw video access symbol may be a Uniform Resource Locator (URL) configured by the publisher.

Further, in the present embodiment, different video publishers may agree on different encryption keys with the first means 110. For a plurality of raw video access symbols assigned by the same video publisher, the video publisher may also agree on different encryption keys with the first means 110 for different raw video access symbols.

For example, if a video publisher A and the first means 110 pre-agree to use a key A for the URL in a directory A and a key B for the URL in a directory B, the first means 110 receives a URL1 (Http://test.com/A/123.MP4) and a URL2 (Http://test.com/B/456.mp4) uploaded by the video publisher A, and uses the key A for encryption of the URL1 and the key B for encryption of the URL2.

Step 2018, encrypting the raw video access symbol according to the second key and a default encryption algorithm to generate the encrypted video access symbol, where the first means 110 for encrypting the video data according to the preset encryption method prestores the default encryption algorithm for encrypting the video access symbol.

Continuing with the above example, in the present embodiment, the default encryption algorithm is a symmetric encryption algorithm AES (Advanced Encryption Standard), and the first means 110 for encrypting the video data according to the preset encryption method encrypts the URL1 using the key A and the AES to obtain an encrypted URL1, and Encrypt the URL2 using the key B and the AES to obtain an encrypted URL2.

It should be noted that in some other feasible embodiments, when step 201 is executed, only steps 2011 to 2016 may be executed, or only steps 2017 and 2018 may be executed; steps 2011 to 2016 may be executed first and then steps 2017 and 2018 may be executed, steps 2017 and 2018 may be executed first and then steps 2011 to 2016 may be executed, or steps 2011 to 2016, steps 2017 and steps 2018 may be executed simultaneously. This specification does not further limit the execution of the substeps of step 202.

Specifically, in a feasible embodiment, step 302 may include the following substeps:
Step 3021, confirming whether the encrypted video data corresponding to the encrypted video access symbol is stored in the object storage according to the encrypted video access symbol;
Step 3022, if so, responding the encrypted video data stored in the object storage to the video playback client device; and
Step 3023, if not, confirming the raw video access symbol corresponding to the encrypted video access symbol based on the encrypted video access symbol, acquiring the encrypted video data based on the raw video access symbol, and responding to the video playback client device.

In the present embodiment, after receiving the raw video data and encrypting the raw video data to generate the encrypted video data, the first means 110 stores the encrypted video data in the object storage for a certain time; after the second device 120 acquires the encrypted video access symbol corresponding to the video playback request sent by the video playback client device, the second means preferentially searches for the encrypted video data in the object storage according to the encrypted video access symbol, and directly responds the encrypted video data to the video playback client device if the corresponding encrypted video data is found in the object storage; and if the corresponding encrypted video data is not found in the object storage, the corresponding raw video access symbol is determined according to the encrypted video access symbol, the corresponding encrypted video data is acquired according to the raw video access symbol, and then the encrypted video data is responded to the video playback client device.

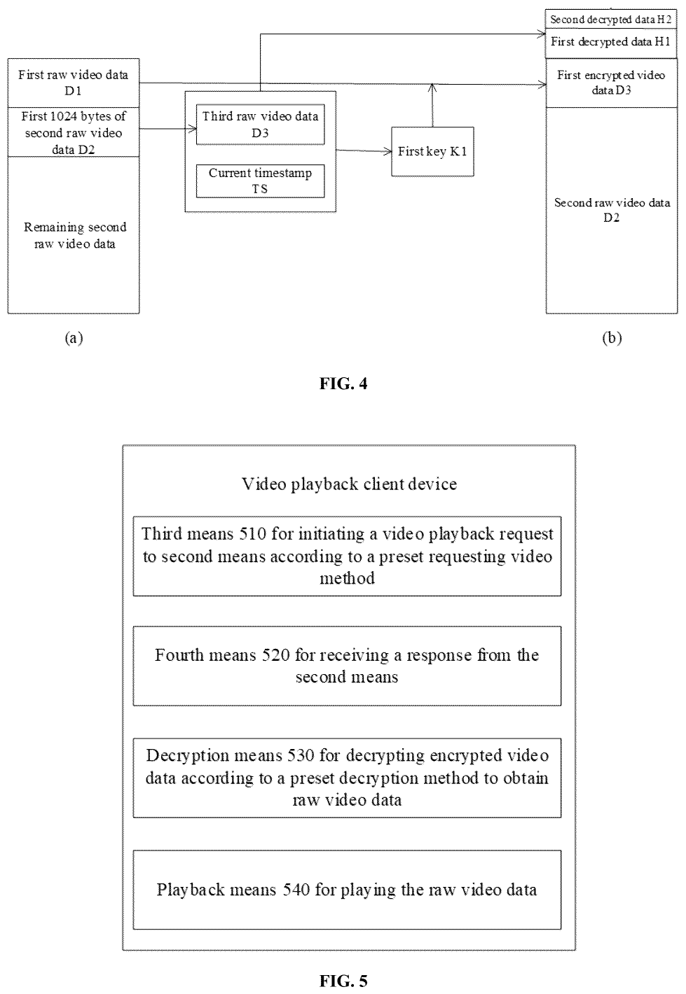

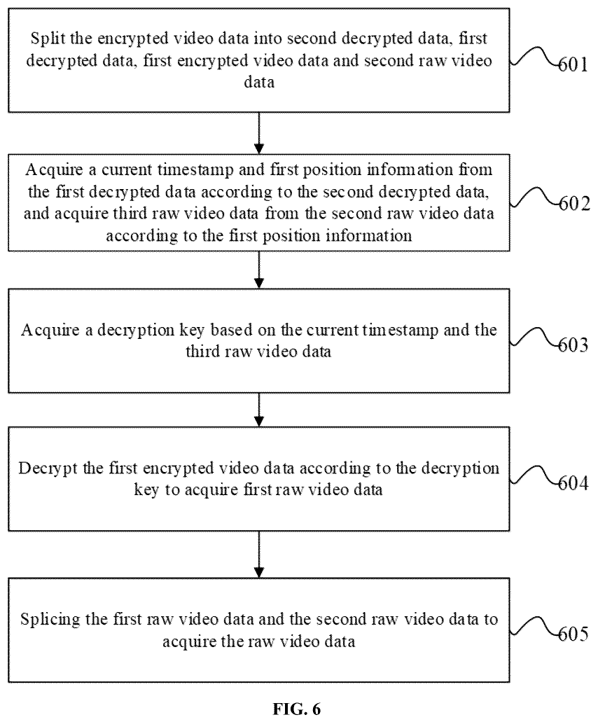

Referring to FIG. 5, FIG. 5 is a structural block diagram of a video playback client device according to Embodiment 2. As shown in FIG. 5, the video playback client device includes third means 510 for initiating a video playback request to second means according to a preset requesting video method, fourth means 520 for receiving a response from the second means, decryption device 530 for decrypting the encrypted video data according to a preset decryption method to obtain raw video data, and playback means 540 for playing the raw video data.

Here, the preset requesting video method executed by the first means 510 for initiating the video playback request to the second means according to the preset requesting video method includes: in response to a video playback instruction initiated by a user, transmitting a video playback request corresponding to the video playback instruction to the second means 120 for disseminating video data according to the preset dissemination method in the secure video dissemination system, and the video playback request is used for the video playback client to pull encrypted video data corresponding to the video playback instruction from the second means 120.

Referring to FIG. 6, FIG. 6 is a flowchart of a preset decryption method executed by decryption means for decrypting the encrypted video data according to the preset decryption method to obtain raw video data according to Embodiment 2, and as shown in FIG. 6, the preset decryption method includes:

Step 601, splitting the encrypted video data into second decrypted data, first decrypted data, first encrypted video data and second raw video data.

In the present embodiment, first 24 bytes of data are extracted from the encrypted video data as the second decrypted data H2, 25th to 1024th bytes of data are extracted from the encrypted video data as the first decrypted data H1, and 1025th to 2048th bytes of data are extracted from the encrypted video data as the first encrypted video data D4.

Step 602, acquiring a current timestamp and first position information from the first decrypted data according to the second decrypted data, and acquiring third raw video data from the second raw video data according to the first position information.

In the present embodiment, second position information of the current timestamp TS and the first position information in the first decrypted data H1 is determined according to the extracted second decrypted data H2, the current timestamp TS and the first position information are acquired from the first decrypted data H1, and the third raw video data D3 is acquired from the second raw video data D2 according to the first position information.

Step 603, acquiring a decryption key based on the current timestamp and the third raw video data.

In the present embodiment, MD5 calculation is performed on the current timestamp TS and the third raw video data D3 to obtain the decryption key K1.

Step 604, decrypting the first encrypted video data according to the decryption key to acquire first raw video data.

In the present embodiment, the first encrypted video data D4 is decrypted based on the decryption key K1 to acquire the first raw video data D1.

In the present embodiment, only the first encrypted video data D4 having a length of 1024 bytes is encrypted, which belongs to lightweight decryption of video data, and can realize fast decryption.

In some embodiments, the first means 110 places a preset encryption algorithm for encrypting the first raw video data at a designated position of the encrypted video data, and in the present embodiment, the preset encryption algorithm needs to be acquired from the designated position before decrypting the first encrypted video data D4.

Step 605, splicing the first raw video data and the second raw video data to acquire the raw video data.

In the present embodiment, the first raw video data D1 and the second raw video data D2 are spliced to acquire the raw video data D1+D2.

In the present embodiment, when the user uses the video playback client device, the video playback client device transmits a video playback request to the second means 120 in the secure video dissemination system in response to the video playback instruction triggered by the user to request the second means 120 to respond the corresponding encrypted video data to the video playback client. After receiving the response from the second means 120, the video playback client device decrypts the encrypted video data by the decryption means 530 to obtain the raw video data, the decryption means 530 decrypts the encrypted video data according to the preset decryption method to obtain the raw video data, and the raw video data is normally played by the playback means 540 for playing the obtained raw video data. Therefore, if there is no decryption means in the video playback client device, the encrypted video data cannot be decrypted, and the video cannot be played normally, thus ensuring the security of video dissemination.

In the present embodiment, the video playback client device pulls the encrypted video data from the second means 120 for disseminating video data according to the preset dissemination method via a Content Delivery Network or Content Distribution Network (CDN).

In the present embodiment, the first means 110 for encrypting video data according to the preset encryption method is written in GO language, and the secure video dissemination system further includes a service gateway and a cache means written in Lua language based on OpenResty. The decryption means 530 of the video playback client device for decrypting the encrypted video data according to the preset decryption method to obtain the raw video data is a decryption Software Development Kit (SDK), which supports both JavaScript language version and Java language version. Therefore, when the video playback client device calls the decryption SDK to decrypt the encrypted video data, fewer resources are occupied, which can avoid overheating of the video playback client device due to high-load operation. The whole system architecture adopts the asynchronous architecture of multi-process coroutine, which fully exploits CPU performance and can meet the needs of a large number of video processing and requests. After stress testing, under a configuration of 1 core CPU and 2 GB memory, and in the same LAN 10 Gbps bandwidth environment, the service gateway is tested with the “ab-c 100-n 10000” command (Apache Bench) and can handle more than 12,000 requests per second; and the encryption means is tested with 5-second slices of HLS-formatted video, and can handle more than 8,000 TS requests per second.

The above system is deployed on the GCP platform (Google Cloud Platform) and uses GCP's Load Balance as the gateway's load balancer externally. The secure video dissemination system adopts a GCP instance group. The service gateway elastically scales up and down instances according to the number of requests, and is responsible for finding a GCS cache. If the cache hits, the service gateway directly responds to the requests, and if the cache misses, the service gateway passes the requests to an encryption component instance group (encryption means) of the secure video dissemination system. The encryption component instance group is elastically scaled according to CPU usage. When the CPU usage reaches 70%, a next instance is elastically scaled up.

In the present embodiment, for the update and upgrade of the above system, since all services are deployed on the GCP platform, when upgrading components, a new set of instances is first created and configured, and then the front-end GCP Load Balance is switched to achieve a smooth transition to a new environment. By observing the console status code, you can roll back to the old environment in time if any problem occurs. For the monitoring and management of the system, the cloud monitoring of the GCP platform is used to monitor the running status of the system in real time, and key data is extracted through GCP PostgreSQL and API to set threshold alarm monitoring. Alarm emails and phone calls are sent to operation and maintenance personnel when abnormal data occurs. For configuration management of the system, all services are deployed in instance groups. These servers are stateless and can be expanded at any time. The configuration adopts the configuration center method. After the service instance is started, the configuration is obtained from the instance group through the intranet. All network address-related configurations use internal DNS resolution, which is convenient for editing and remote disaster recovery, and achieves high service availability.

The system or means described in the above embodiments may be implemented by a computer chip or an entity, or by a product with a certain function. A typical implementation device is a computer, which may be in the form of a personal computer, a laptop computer, a cellular phone, a camera phone, a smart phone, a personal digital assistant, a media player, a navigation device, an email transceiver device, a game console, a tablet computer, a wearable device, or a combination of any of these devices.

In a typical configuration, a computer includes one or more processors (CPUs), input/output interfaces, network interfaces and a memory.

The memory may include non-permanent memory in a computer-readable medium, a Random Access Memory (RAM) and/or a non-volatile memory in the form of a Read-Only Memory (ROM) or a flash RAM. The memory is an example of a computer-readable medium. Computer-readable media, including permanent and non-permanent, removable and non-removable media, may be implemented by any method or technique for information storage. The information can be computer-readable instructions, data structures, modules of programs, or other data. Examples of storage media of a computer include, but are not limited to, Phase-Change Memory (PRAM), Static Random Access Memory (SRAM), Dynamic Random Access Memory (DRAM), other types of Random Access Memory (RAM), Read-Only Memory (ROM), Electrically Erasable Programmable Read-Only Memory (EEPROM), flash memory or other memory technology, Compact Disc Read-Only Memory (CD-ROM), Digital Versatile Disc (DVD) or other optical storage, magnetic cartridges, magnetic disk storage, quantum memory, graphene-based storage media or other magnetic storage devices, or any other non-transmission media that can be used to store information that can be accessed by a computing device. As defined herein, computer-readable media does not include transitory media, such as modulated data signals and carriers.

What is claimed is:

1. A secure video dissemination system, comprising:
first means for encrypting video data according to a preset encryption method, the preset encryption method comprising:
receiving raw video data and a raw video access symbol transmitted by a video publisher and generating encrypted video data and an encrypted video access symbol; and
storing the encrypted video data to an object storage, and returning the encrypted video access symbol to the video publisher; and
second means for disseminating video data according to a preset dissemination method, the preset dissemination method comprising:
receiving a video playback request sent by a video playback client device and acquiring an encrypted video access symbol corresponding to the video playback request; and
responding the encrypted video data corresponding to the encrypted video access symbol to the video playback client device, so that the video playback client device can call decryption means with a preset decryption method to decrypt the encrypted video data to obtain the raw video data, the decryption means being preinstalled in the video playback client.

2. The secure video dissemination system according to claim 1, wherein the receiving the raw video data and the raw video access symbol transmitted by the video publisher and generating the encrypted video data and the encrypted video access symbol comprises:
sharding the raw video data into first raw video data and second raw video data;
randomly extracting third raw video data having a preset length from the second raw video data and recording first position information of the third raw video data, the first position information referring to position information of the third raw video data in the second raw video data;
acquiring a first key based on the third raw video data and a current timestamp;
encrypting the first raw video data according to the first key and a preset encryption algorithm to acquire first encrypted video data, the preset encryption algorithm for encrypting the video data being prestored in the first means;
generating first decrypted data and second decrypted data based on the current timestamp and the third raw video data, the first decrypted data comprising the current timestamp and first position information, the second decrypted data comprising second position information of the current timestamp and the third raw video data in the first decrypted data; and
splicing the second decrypted data, the first decrypted data, the first encrypted video data and the second raw video data to generate the encrypted video data.

3. The secure video dissemination system according to claim 1, wherein the receiving the raw video data and the raw video access symbol transmitted by the video publisher and generating the encrypted video data and the encrypted video access symbol comprises:
extracting first 1024 bytes of data from the raw video data as the first raw video data, and using the remaining data that is not extracted as the second raw video data;
randomly extracting the third raw video data having a length of 8 bytes from first 1024 bytes of the second raw video data, and acquiring the first position information of the third raw video data, the first position information referring to the position information of the third raw video data in the second raw video data;
performing MD5_hash calculation on the third raw video data and the current timestamp to obtain the first key;
randomly extracting a symmetric encryption method from a preset symmetric encryption algorithm set as the preset encryption algorithm, and encrypting the first raw video data using the first key and the preset encryption algorithm to acquire the first encrypted video data, the preset symmetric encryption algorithm set is prestored in the first means;
randomly generating the first decrypted data having a length of 1000 bytes based on the current timestamp and the first position information, recording second position information of the current timestamp and the first position information in the first decrypted data, and generating the second decrypted data having a length of 24 bytes according to the second position information; and
splicing the second decrypted data, the first decrypted data, the first encrypted video data and the second raw video data to generate the encrypted video data.

4. The secure video dissemination system accord to claim 3, wherein the preset symmetric encryption algorithm set comprises AES, DES and 3DES.

5. The secure video dissemination system according to claim 1, wherein the receiving the raw video data and the raw video access symbol transmitted by the video publisher and generating the encrypted video data and the encrypted video access symbol comprises:
determining a preset second key according to the raw video access symbol; and
encrypting the raw video access symbol according to the second key and a default encryption algorithm to generate the encrypted video access symbol, the default encryption algorithm for encrypting the video access symbol being prestored in the first means.

6. The secure video dissemination system according to claim 5, wherein the default encryption algorithm is AES.

7. The secure video dissemination system according to claim 1, wherein the method of responding the encrypted video data corresponding to the encrypted video access symbol to the video playback client device comprises:
confirming whether the encrypted video data corresponding to the encrypted video access symbol is stored in the object storage according to the encrypted video access symbol;
if so, responding the encrypted video data stored in the object storage to the video playback client device; and
if not, confirming the raw video access symbol corresponding to the encrypted video access symbol based on the encrypted video access symbol, acquiring the encrypted video data based on the raw video access symbol, and responding to the video playback client device.

8. A video playback client device applied to a secure video dissemination system, comprising:
third means for initiating a video playback request to second means in a secure video dissemination system according to a preset requesting video method, the preset requesting video method comprising:
in response to a video playback instruction initiated by a user, transmitting a video playback request corresponding to the video playback instruction to the second means in the secure video dissemination system, the video playback request being used for the video playback client device to pull encrypted video data corresponding to the video playback instruction from the second means in the secure video dissemination system;
fourth means for receiving a response from the second means of the secure video dissemination system;
decryption means for decrypting the encrypted video data according to a preset decryption method to obtain raw video data; and
playback means for playing the raw video data.

9. The video playback client device applied to the secure video dissemination system according to claim 8, wherein the preset decryption method comprises:
splitting the encrypted video data into second decrypted data, first decrypted data, first encrypted video data and second raw video data;
acquiring a current timestamp and first position information from the first decrypted data according to the second decrypted data, and acquiring third raw video data from the second raw video data according to the first position information;
acquiring a decryption key based on the current timestamp and the third raw video data;
decrypting the first encrypted video data based on the decryption key to acquire first raw video data; and
splicing the first raw video data and the second raw video data to acquire the raw video data.

10. The video playback client device applied to the secure video dissemination system according to claim 9, wherein the preset decryption method comprises:
extracting first 24 bytes of data from the encrypted video data as the second decrypted data, extracting 25th to 1024th bytes of data from the encrypted video data as the first decrypted data, and extracting 1025th to 2048th bytes of data from the encrypted video data as the first encrypted video data;
determining second position information of the current timestamp and the first position information in the first decrypted data according to the extracted second decrypted data, acquiring the current timestamp and the first position information from the first decrypted data, and acquiring the third raw video data from the second raw video data according to the first position information;
performing MD5 calculation on the current timestamp and the third raw video data to obtain a decryption key;
decrypting the first encrypted video data based on the decryption key to acquire first raw video data; and
splicing the first raw video data and the second raw video data to acquire the raw video data.
